(19) United States
(12) Patent Application Publication
(10) Pub. No.: US 2023/0352974 A1
(43) Pub. Date: Nov. 2, 2023

(54) ELECTRONIC DEVICE, OPERATION SYSTEM AND POWER SUPPLY METHOD

(71) Applicant: Nuvoton Technology Corporation, Hsinchu Science Park (TW)

(72) Inventors: Cheng-Chih WANG, Jhubei City (TW); Chih-Wei TSAI, Jhubei City (TW); Tzu-Lan SHEN, Taoyuan City (TW); Yan-Chin HUANG, Jhunan Township (TW)

(21) Appl. No.: 18/092,080

(22) Filed: Dec. 30, 2022

(30) Foreign Application Priority Data
Apr. 29, 2022 (TW) 111116426

(51) Int. Cl. H02J 50/00; H02J 50/80

(52) U.S. Cl. CPC H02J 50/001; H02J 50/80

(57) ABSTRACT

An electronic device including a power supply device and a load is provided. The power supply device includes an energy harvest circuit, a power management circuit, and an energy storage element. The energy harvest circuit receives a wireless signal and harvests energy from the wireless signal to generate a first output voltage. The power management circuit processes the first output voltage to generate a second output voltage. The energy storage element is charged by the second output voltage to provide an operation voltage. The load operates according to the operation voltage.

### CROSS REFERENCE TO RELATED APPLICATIONS

This application claims priority of Taiwan Patent Application No. 111116426, filed on Apr. 29, 2022, the entirety of which is incorporated by reference herein.

### BACKGROUND OF THE INVENTION

### Field of the Invention

The invention relates to an electronic device, and more particularly to an electronic device that harvests the energy of wireless signal.

### Description of the Related Art

With technological development, the types and functions of electronic devices have increased. Most electronic devices have a built-in rechargeable battery to maintain the normal operation of electronic devices. A user may need to remove the rechargeable battery at regular intervals, and then use mains electricity to charge the rechargeable battery. However, some rechargeable batteries are not easy to disassemble, such as those used in smoke detectors. Therefore, it is difficult to charge these rechargeable batteries.

### BRIEF SUMMARY OF THE INVENTION

In accordance with an embodiment of the disclosure, an electronic device comprises a power supply device and a load. The power supply device comprises an energy harvest circuit, a power management circuit, and an energy storage element. The energy harvest circuit receives a wireless signal and harvests energy from the wireless signal to generate a first output voltage. The power management circuit processes the first output voltage to generate a second output voltage. The energy storage element is charged by the second output voltage to provide an operation voltage. The load operates according to the operation voltage.

In accordance with another embodiment of the disclosure, an operation system comprises an external device and an electronic device. The electronic device communicates with the external device via a wireless signal and comprises an energy harvest circuit, a power management circuit, an energy storage element, and a load. The energy harvest circuit receives the wireless signal and harvests energy from the wireless signal to generate a first output voltage. The power management circuit processes the first output voltage to generate a second output voltage. The energy storage element is charged by the second output voltage to provide an operation voltage. The load operates according to the operation voltage.

An exemplary embodiment of a power supply method for providing an operation voltage to a load is described in the following paragraph. A wireless signal is received. The energy from the wireless signal is harvested to generate a first output voltage. The first output voltage is processed to generate a second output voltage. An energy storage element is charged by the second output voltage. The voltage stored in the energy storage element is provided as the operation voltage. The operation voltage is output to the load.

Power supply methods may be practiced by a micro-controller chip which have hardware or firmware capable of performing particular functions and may take the form of program code embodied in a tangible media. When the program code is loaded into and executed by an electronic device, a processor, a computer or a machine, the electronic device, the processor, the computer or the machine becomes a power supply device for practicing the disclosed method.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of an operation system according to various aspects of the present disclosure.

FIG. 2 is a schematic diagram of an exemplary embodiment of a power supply device according to various aspects of the present disclosure.

FIG. 3 is a schematic diagram of another exemplary embodiment of the operation system according to various aspects of the present disclosure.

FIG. 4A is a flowchart of an exemplary embodiment of a power supply method according to various aspects of the present disclosure.

FIG. 4B is a flowchart of another exemplary embodiment of the power supply method according to various aspects of the present disclosure.

FIG. 4C is a flowchart of another exemplary embodiment of the power supply method according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

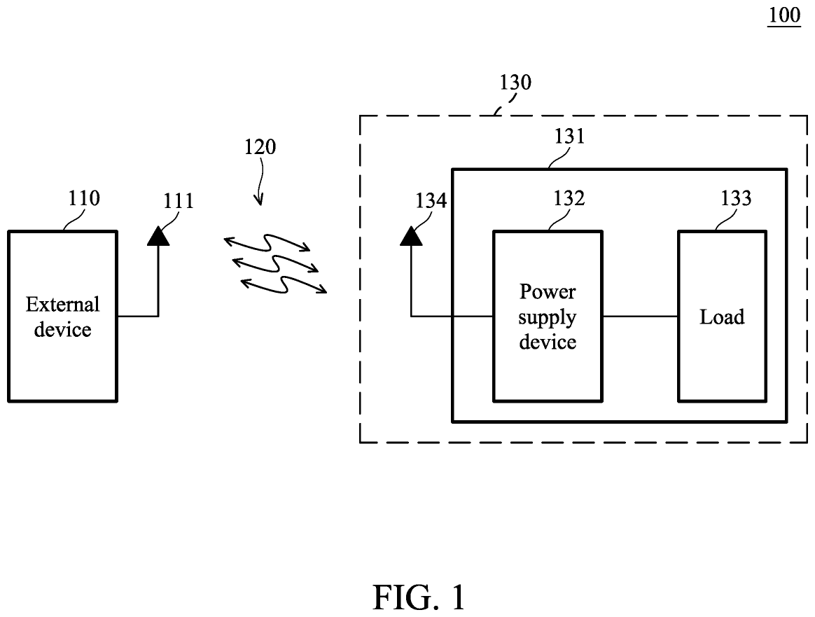

FIG. 1 is a schematic diagram of an exemplary embodiment of an operation system according to various aspects of the present disclosure. The operation system 100 comprises an external device 110 and an electronic device 130. The external device 110 is disposed independent of the electronic device 130. The electronic device 130 communicates with the external device 110 via the wireless signal 120. The kind of wireless signal 120 is not limited in the present disclosure. In one embodiment, the wireless signal 120 is a wireless-fidelity (WiFi) signal, an infrared (IR) signal or a Bluetooth signal.

The external device 110 comprises an antenna 111. The antenna 111 emits wireless signals to the electronic device 130 or receive the wireless signals from the electronic device 130. In this embodiment, the wireless signals emitted from and received by the antenna 111 are referred to as the wireless signal 120. The kind of external device 110 is not limited in the present disclosure. In one embodiment, the external device 110 is a wireless access point. In this case, the external device 110 is connected to the internet to retrieve network message and then transmit to the electronic device 130 or another electronic device, which is not shown in FIG. 1 and may be a mobile phone via the antenna 111. In another embodiment, the external device 110 is a mobile device, such as a cleaning robot.

The electronic device 130 comprises an antenna 134. The antenna 134 is configured to receive the wireless signals from the external device 110 or emits wireless signals to the external device 110. In this embodiment, the wireless signals emitted from the antenna 134 and the wireless signals received by the antenna 134 are referred to as the wireless signal 120. The kind of electronic device 130 is not limited in the present disclosure. In one embodiment, the electronic device 130 may be an internet of things (IOT) devices, a clock, an electronic door lock, or a sensor device, such as CO detector, a smoke detector.

In one embodiment, the electronic device 130 harvests and uses the energy of the wireless signal 120. Therefore, there is no battery in the electronic device 130 such that the number of waste batteries is reduced and the purpose of reducing carbon and saving resources is achieved. Additionally, the electronic device 130 is capable of effectively utilizing the wireless signal of the surrounding environment.

In other embodiments, the electronic device 130 may comprise a rechargeable battery (not shown). In this case, the electronic device 130 uses the energy of the wireless signal 120 to charge the rechargeable battery such that the rechargeable battery has enough sufficient power. Therefore, the user does not need to unplug the rechargeable battery, and then use mains electricity to charge the rechargeable battery. The electricity consumption of the home or company is reduced and the purpose of saving energy is achieved.

The structure of electronic device 130 is not limited in the present disclosure. In one embodiment, the electronic device 130 comprises a case 131, a power supply device 132, and a load 133. The power supply device 132 and the load 133 are disposed inside of the case 131. The power supply device 132 harvests and converts the energy of the wireless signal 120 to provide power to the load 133. The kind of load 133 is not limited in the present disclosure. In one embodiment, if the electronic device 130 is a clock, the load 133 is a device which is capable of displaying time.

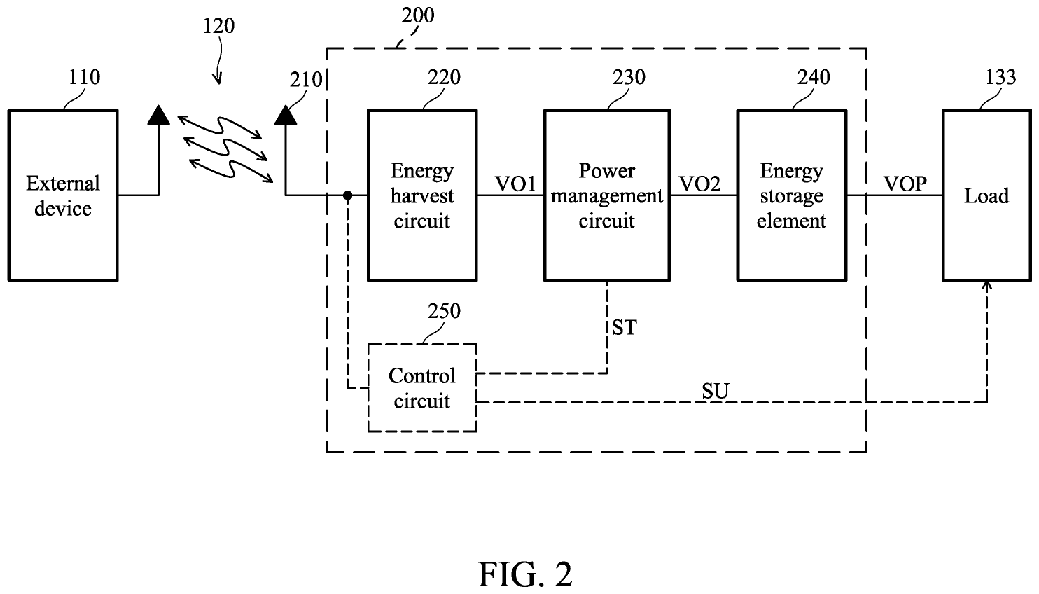

FIG. 2 is a schematic diagram of an exemplary embodiment of a power supply device according to various aspects of the present disclosure. The power supply device 200 comprises an energy harvest circuit 220, a power management circuit 230, and an energy storage element 240. In some embodiments, the structure of the power supply device 132 is similar to the structure of the power supply device 200. The energy harvest circuit 220 receives the wireless signal 120 via the antenna 210 and harvests the energy of the wireless signal 120 to generate an output voltage VO1. The structure of energy harvest circuit 220 is not limited in the present disclosure. Any circuit can serve the energy harvest circuit 220, as long as the circuit is capable of harvesting energy from a wireless signal.

The power management circuit 230 processes the output voltage VO1 to generate an output voltage VO2. The disclosure does not limit how the power management circuit 230 processes the output voltage VO1. In one embodiment, the power management circuit 230 at least comprises a rectifier (not shown) and a boost circuit (not shown). The rectifier performs a rectification operation for the output voltage VO1. The boost circuit boosts the rectified voltage generated by the rectifier. In such cases, the boosted voltage is provided as the output voltage VO2. In one embodiment, the output voltage VO1 is about 0.2V, and the output voltage VO2 is about 1.2V.

The energy storage element 240 is charged according to the output voltage VO2 and provides an operation voltage VOP to the load 133. The load 133 operates according to the operation voltage VOP. The kind of energy storage element 240 is not limited in the present disclosure. In one embodiment, the energy storage element 240 is a rechargeable battery. The power management circuit 230 auto-charges the energy storage element 240 to ensures that the load 133 properly operates. Furthermore, the user does not need to manually unplug the energy storage element 240 and then use mains electricity to charge the energy storage element 240. Therefore, the convenience of electronic devices 130 is greatly improved, and the consumption of mains electricity is reduced.

In other embodiments, the energy storage element 240 is omitted from the power supply device 200. In this case, the power management circuit 230 serves the output voltage VO2 as the operation voltage VOP and provides the operation voltage VOP to the load 133. For example, assume that the external device 110 is a wireless access point in house. In such cases, since the external device 110 continuously supplies the output voltage VO2 to the load 133, the energy storage element 240 can be omitted. Since no battery is disposed in the power supply device 200, the carbon reduction effect is achieved.

In one embodiment, the power supply device 200 further comprises a control circuit 250. The control circuit 250 emits the wireless signal 120 via the antenna 210 to communicate with the external device 110. The control circuit 250 updates the state of the load 133 according to the message from the external device 110. For example, assume that the load 133 is a clock. In this case, the control circuit 250 utilizes the wireless signal 120 to direct the external device 110 to respond to a time message. The external device 110 may connect to the internet and obtains a time message from the internet. The external device 110 utilizes the wireless signal 120 to provide the time message to the control circuit 250. The control circuit 250 generates an update signal SU according to the time message to update the time displayed on the load 133. In other embodiments, the load 133 displays temperature information, humidity information, or weather information. In such cases, the control circuit 250 utilizes the wireless signal 120 to direct the external device 110 to provide a temperature message, a humidity message, or a weather message. The control circuit 250 generates the update signal SU according to the messages from the external device 110. The load 133 changes the displayed information, such as the temperature information, the humidity information, or the weather information.

In some embodiments, when the output voltage VO2 or the operation voltage VOP drops, the control circuit 250 directs the external device 110 to increase the intensity of the wireless signal 120. For example, assume that the energy storage element 240 is not disposed in the power supply device 200. In this case, the control circuit 250 determines whether to direct the external device 110 to increase the intensity of the wireless signal 120 according to the output voltage VO2. If the energy storage element 240 is disposed in the power supply device 200, the control circuit 250 determines whether to direct the external device 110 to increase the intensity of the wireless signal 120 according to the output voltage VO2 or the operation voltage VOP. For brevity, assume that the control circuit 250 determines whether to direct the external device 110 to increase the intensity of the wireless signal 120 according to the operation voltage VOP.

When the operation voltage VOP is less than a threshold value, the control circuit 250 directs the external device 110 to increase the intensity of the wireless signal 120. Since the energy harvest circuit 220 is capable of harvesting more energy, the operation voltage VOP quickly returns to the predetermined value, such as 1.2V. In one embodiment, when the operation voltage VOP is less than a threshold value, the control circuit 250 enters an operation mode from a sleep mode. In the operation mode, the control circuit 250 communicates with external device 110 to direct the external device 110 to increase the intensity of the wireless signal 120. When the operation voltage VOP is not less than a threshold value, the control circuit 250 exits the operation mode and enters the sleep mode. In the sleep mode, the control circuit 250 stops communicating with the external device 110. Since the control circuit 250 stops operating, the power consumption of the power supply device 200 is reduced.

In other embodiments, when the control circuit 250 enters the sleep mode, the control circuit 250 disables the energy harvest circuit 220 and the power management circuit 230 such that the energy harvest circuit 220 and the power management circuit 230 stop operating. In this case, the power management circuit 230 may detect the operation voltage VOP every a fixed time interval. When the operation voltage VOP is less than a threshold value, the power management circuit 230 wakes up the control circuit 250 via the trigger signal ST. Therefore, the control circuit 250 exits the sleep mode and enters the operation mode. In the operation mode, the control circuit 250 directs the energy harvest circuit 220 and the power management circuit 230 to start operating.

In one embodiment, the power management circuit 230 detects the operation voltage VOP. When the operation voltage VOP is less than a threshold value, the power management circuit 230 enables the trigger signal ST. Therefore, the control circuit 250 enters an operation mode. In the operation mode, the control circuit 250 direct the external device 110 to increase the intensity of the wireless signal 120. When the operation voltage VOP is not less than a threshold value, the power management circuit 230 does not enable the trigger signal. In other words, the power management circuit 230 disable the trigger signal when the operation voltage VOP is not less than a threshold value. Therefore, the control circuit 250 enters a sleep mode. In the sleep mode, the control circuit 250 stops communicating with the external device 110. In this case, the power management circuit 230 may comprise a voltage detection circuit (not shown) to detect the operation voltage VOP. In another embodiment, the voltage detection circuit is combined in the control circuit 250. In this case, the control circuit 250 detects the operation voltage VOP and determines whether the operation voltage VOP is less than a threshold value.

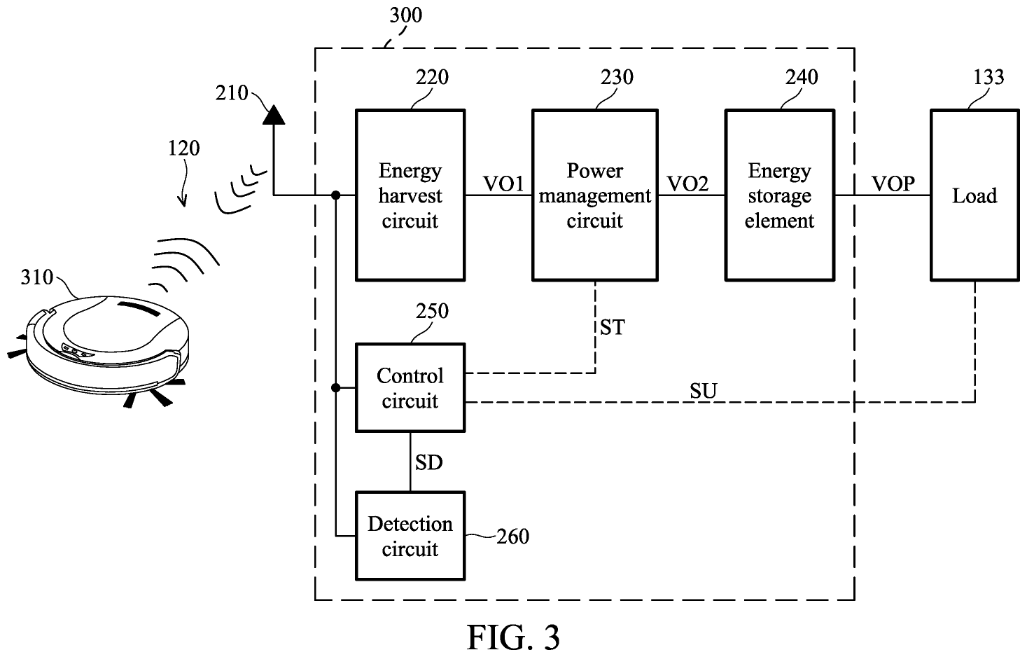

FIG. 3 is a schematic diagram of another exemplary embodiment of the operation system according to various aspects of the present disclosure. The power supply device 300 of FIG. 3 is similar to the power supply device 200 FIG. 2 exception that the power supply device 300 further comprises a detection circuit 260. The detection circuit 260 detects the location of the external device 310 to generate a detection signal SD.

In this embodiment, the control circuit 250 determines whether the distance between the external device 310 and the power supply device 300 is less than a predetermined distance. When the distance between the external device 310 and the power supply device 300 is not less than a predetermined distance, the detection circuit 260 directs the control circuit 250 to enter a sleep mode via the detection signal SD. In the sleep mode, the control circuit 250 stops operating, for example, the control circuit 250 stops communicating with the external device 310.

In some embodiments, the external device 310 is a mobile device, such as a cleaning robot. In this case, the power supply device 300 is disposed in the path that the external device 310 must pass through. The case in which the detection circuit 260 receives the wireless signal 120 via the antenna 210 indicates that the external device 310 approaches the power supply device 300. Therefore, the detection circuit 260 generates the detection signal SD according to the intensity of the wireless signal 120. When the detection signal SD reaches a target voltage, it is determined that the distance between the external device 310 and the power supply device 300 is less than a predetermined distance. Therefore, the control circuit 250 emits the wireless signal 120 via the antenna 210 to control the movement path of the external device 310. In this case, the control circuit 250 may direct the external device 310 to increase the time it stays near the power supply device 300. Therefore, the energy harvest circuit 220 is capable of harvesting the energy of the wireless signal 120 to charge the energy storage element 240. In another embodiment, when the distance between the external device 310 and the power supply device 300 is less than a predetermined distance, the detection circuit 260 wakes up the control circuit 250 via the detection signal SD. The control circuit 250 exits the sleep mode and enters an operation mode. In the operation mode, the control circuit 250 communicates with the external device 310.

In other embodiments, the control circuit 250 not only directs the external device 310 to increase the time it stays near the power supply device 300, but also direct the external device 310 to increase the intensity of the wireless signal 120. For example, when the distance between the external device 310 and the power supply device 300 is less than a predetermined distance, if the operation voltage VOP is less than a threshold value, the control circuit 250 directs the external device 310 to increase the intensity of the wireless signal 120. Since the energy harvest circuit 220 receives more energy, the operation voltage VOP quickly increases to a target value, such as 1.2V. When the operation voltage VOP is higher than the threshold value, the control circuit 250 directs the external device 310 to restore the intensity of the wireless signal 120 to an initial intensity. In this case, the control circuit 250 may direct the external device 310 to remove from the power supply device 300.

In some embodiments, when the distance between the external device 310 and the power supply device 300 is not less than a predetermined distance, the control circuit 250 operates in a sleep mode. At this time, the energy harvest circuit 220 may stop operating. When the distance between the external device 310 and the power supply device 300 is less than a predetermined distance, the detection circuit 260 wakes up the energy harvest circuit 220. At this time, the control circuit 250 may maintain at the sleep mode or exit the sleep mode. If the control circuit 250 exits the sleep mode, the control circuit 250 enters an operation mode. In the operation mode, the control circuit 250 directs the external device 310 to move around the power supply device 300. In another embodiment, when the distance between the external device 310 and the power supply device 300 is less than a predetermined distance, the control circuit 250 maintains at the sleep mode until the operation voltage VOP is less than a threshold value. In this case, when the operation voltage VOP is less than a threshold value, the control circuit 250 exits the sleep mode and enters an operation mode. When the control circuit 250 enters the operation mode, the control circuit 250 directs the external device 310 to increase the intensity of the wireless signal 120.

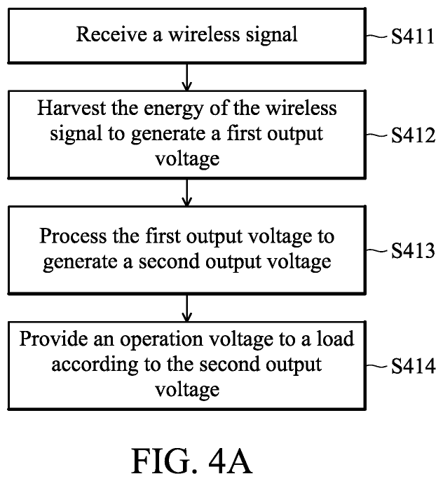

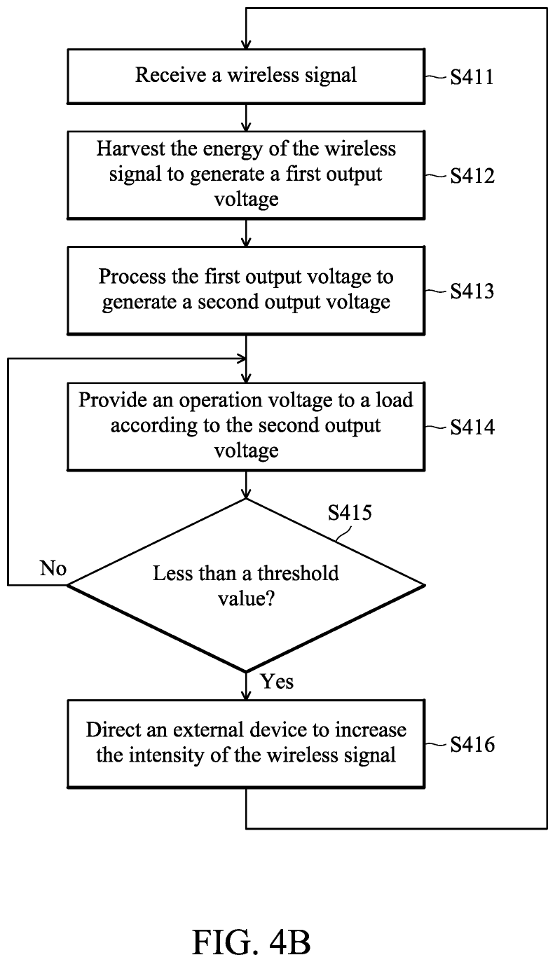

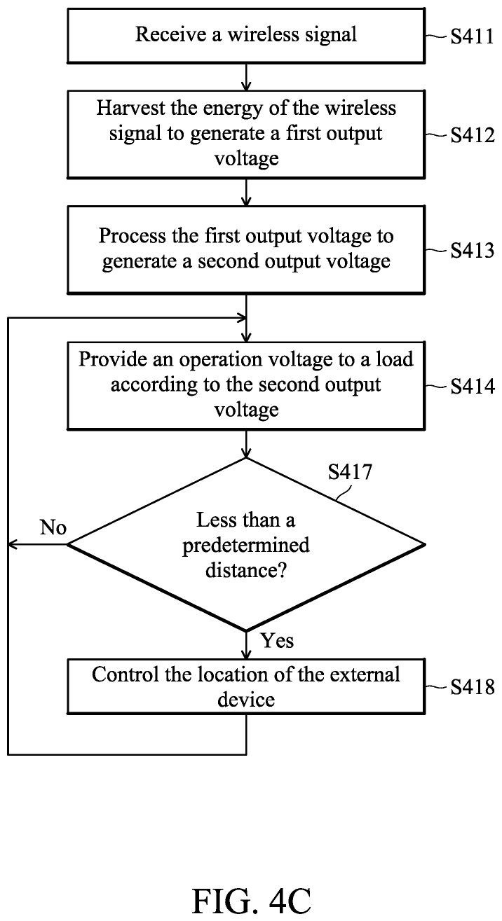

FIG. 4A is a flowchart of an exemplary embodiment of a power supply method according to various aspects of the present disclosure. The power supply method is applied in a power supply device to provide an operation voltage to a load. First, a wireless signal is received (step S411). In one embodiment, the wireless signal is provided by an external device. The external device is disposed independent of the power supply device. The kind of wireless signal is not limited in the present disclosure. In one embodiment, the wireless signal is a WiFi signal, an IR signal, or a Bluetooth signal.

Next, the energy of the wireless signal is harvested to generate a first output voltage (step S412). In one embodiment, step S412 is to utilize a harvester to harvest the energy of the wireless signal.

Then, the first output voltage is processed to generate a second output voltage (step S413). In one embodiment, S413 is to perform a rectification operation for the first output voltage and then boost the rectified voltage. In such cases, the boosted voltage is provided as the second output voltage.

Next, an operation voltage is provided to a load according to the second output voltage (step S414). In other embodiments, step S414 is to use the second output voltage to charge an energy storage element, serve the voltage stored in the energy storage element as the operation voltage, and provide the operation voltage to a load. The load operates according to the operation voltage. In some embodiments, step S414 can be omitted. In such cases, the second output voltage generated by step S413 is served as an operation voltage and is provided to the load.

FIG. 4B is a flowchart of another exemplary embodiment of the power supply method according to various aspects of the present disclosure. FIG. 4B is similar to FIG. 4A except for the addition of steps S415 and S416. Step S415 is to determine whether the operation voltage is less than a threshold value. When the operation voltage is not less than the threshold value, step S414 is performed to continuously provide the operation voltage to a load. When the operation voltage is less than a threshold value, step S416 is to direct an external device to increase the intensity of the wireless signal.

FIG. 4C is a flowchart of another exemplary embodiment of the power supply method according to various aspects of the present disclosure. FIG. 4C is similar to FIG. 4A except for the addition of steps S417 and S418. Step S417 is to determine whether the distance between the external device and the power supply device is less than a predetermined distance. When the distance between the external device and the power supply device is not less than a predetermined distance, step S414 is performed to continuously provide the operation voltage to a load. When the distance between the external device and the power supply device is less than a predetermined distance, the location of the external device is controlled such that the distance between the external device and the power supply device is maintained within a predetermined range (step S418). Then, step S414 is performed to continuously provide the operation voltage to a load.

In some embodiments, steps S415 and S416 of FIG. 4B are performed after step S418 of FIG. 4C. In such cases, step S418 is to control the distance between the external device and the power supply device is within a predetermined range. Then, a determination is made as to whether the operation voltage is less than a threshold value. When the operation voltage is not less than a threshold value, step S414 is performed to continuously provide the operation voltage to a load. When the operation voltage is less than a threshold value, the intensity of the wireless signal is increased by the external device. Then, step S411 is performed.

In some embodiments, the load may comprise a rechargeable battery to store the operation voltage. However, since the operation voltage of the load is provided by a wireless signal, the user does not need to use mains electricity to charge the rechargeable battery. Therefore, the purpose of saving energy is achieved. Additionally, when the wireless signal is emitted continuously, since the load can receive the operation voltage continuously, no additional rechargeable battery is required. Therefore, the number of waste batteries is reduced and the purpose of reducing carbon is achieved.

Power supply methods may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a power supply device for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a power supply device for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a power supply device comprising:
an energy harvest circuit receiving a wireless signal and harvesting energy from the wireless signal to generate a first output voltage;
a power management circuit processing the first output voltage to generate a second output voltage; and
an energy storage element, which is charged by the second output voltage to provide an operation voltage; and
a load operating according to the operation voltage.

2. The electronic device as claimed in claim 1, wherein power supply device further comprises:
a control circuit communicating with an external device to update the state of the load.

3. The electronic device as claimed in claim 2, wherein the control circuit updates time information displayed by the load.

4. The electronic device as claimed in claim 2, wherein the power supply device further comprises:
a detection circuit detecting whether a distance between the external device and the power supply device is less than a predetermined distance.

5. The electronic device as claimed in claim 4, wherein in response to the distance between the external device and the power supply device being less than the predetermined distance, the control circuit directs the external device to move within a predetermined area.

6. The electronic device as claimed in claim 4, wherein in response to the distance between the external device and the power supply device being less than the predetermined distance, the control circuit directs the external device to increase the intensity of the wireless signal.

7. The electronic device as claimed in claim 4, wherein in response to the distance between the external device and the power supply device not being less than the predetermined distance, the control circuit stops communicating with the external device.

8. The electronic device as claimed in claim 2, wherein in response to the operation voltage being less than a threshold value, the control circuit directs the external device to increase the intensity of the wireless signal, and in response to the operation voltage not being less than the threshold value, the control circuit directs the external device to respond to the intensity of the wireless signal.

9. The electronic device as claimed in claim 8, wherein the power management circuit detects the operation voltage, in response to the operation voltage being less than the threshold value, the power management circuit enables a trigger signal, and in response to the operation voltage not being less than the threshold value, the power management circuit disable the trigger signal.

10. The electronic device as claimed in claim 9, wherein:
in response to the trigger signal being disabled, the control circuit enters a sleep mode and the energy harvest circuit stops operating, and
in response to the trigger signal being enabled, the control circuit enters an operation mode and the energy harvest circuit starts to operate.

11. An operation system comprising:
an external device; and
an electronic device communicating with the external device via a wireless signal and comprising:
an energy harvest circuit receiving the wireless signal and harvesting energy from the wireless signal to generate a first output voltage;
a power management circuit processing the first output voltage to generate a second output voltage;
an energy storage element, which is charged by the second output voltage to provide an operation voltage; and
a load operating according to the operation voltage.

12. The operation system as claimed in claim 11, further comprising:
a control circuit communicating with the external device via the wireless signal to obtain a time message and updating time information displayed by the load according to the time message,
wherein the external device is a wireless access point which is connected to the internet and obtains the time message via the internet, and the external device provides the time message to the control circuit.

13. The operation system as claimed in claim 12, wherein in response to the operation voltage being less than a threshold value, the control circuit uses the wireless signal to direct the external device to increase the intensity of the wireless signal.

14. The operation system as claimed in claim 13, wherein in response to the operation voltage not being less than the threshold value, the control circuit stops communicating with the external device.

15. The operation system as claimed in claim 11, wherein the external device is a cleaning robot.

16. The operation system as claimed in claim 15, wherein the electronic device further comprises:
a detection circuit detecting a distance between the external device and the electronic device; and
a control circuit, which uses the wireless signal to control a movement path of the external device in response to the distance between the external device and the electronic device being less than a predetermined distance.

17. The operation system as claimed in claim 16, wherein in response to the operation voltage being less than a threshold value, the control circuit uses the wireless signal to direct the external device to increase the intensity of the wireless signal.

18. The operation system as claimed in claim 16, wherein in response to the distance between the external device and the electronic device not being less than the predetermined distance, the control circuit stops communicating with the external device.

19. A power supply method for providing an operation voltage to a load and comprising:
receiving a wireless signal;
harvesting energy from the wireless signal to generate a first output voltage;
processing the first output voltage to generate a second output voltage;
charging an energy storage element using the second output voltage, wherein the voltage stored in the energy storage element is provided as the operation voltage; and
outputting the operation voltage to the load.

20. The power supply method as claimed in claim 19, further comprising:
detecting the operation voltage,
wherein in response to the operation voltage being less than a threshold value, the intensity of the wireless signal is increased.
